(19) United States
(12) Patent Application Publication
(10) Pub. No.: US 2009/0086095 A1
(43) Pub. Date: Apr. 2, 2009

(54) Method and apparatus for overlaying encoded streams

(75) Inventors: Robert A. Boger, Sioux City, IA (US); Jeffery D. Zolnowsky, Vermillion, SD (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/904,768

(22) Filed: Sep. 28, 2007

(51) Int. Cl. H04N 7/58

(52) U.S. Cl. 348/473; 375/E07.268; 375/240.26

(57) ABSTRACT

A display device for overlaying encoded steams includes a decoder within the display device for decoding a primary encoded stream and a secondary encoded stream to produce a primary unencoded stream and a secondary unencoded stream including secondary information and overlay information. The display device includes an overlay controller for combining the primary unencoded stream and the secondary unencoded stream to produce a composite stream. The display device includes a display adapted to display images corresponding to the composite stream, the images including a primary image corresponding to the primary unencoded stream and a secondary image corresponding to the secondary information overlaid on the primary image corresponding to the overlay information.

### BACKGROUND AND SUMMARY

The present invention relates generally to overlaying video signals and, more specifically, to overlaying encoded video streams in a display device.

Digitally encoded video streams allow high quality video information to be transmitted reliably, efficiently, and securely. These streams must be decoded before they can be displayed. The streams also typically include audio information and it will be understood that references to streams or video streams is not meant to exclude streams including audio information.

Methods for decoding digital signals are known. Ordinarily, a decoder will convert the encoded digital stream to a format suitable for processing and/or display. For native digital displays (e.g., plasma and LCD displays), the suitable format will ordinarily be a raw (decompressed and decoded) digital stream (e.g., DVI). For analog displays, the suitable format will ordinarily be an analog signal (e.g., component video). The conversion process typically includes decryption, decompression, and decoding specific to the format of the encoded stream.

In equipment for displaying digitally encoded streams, the streams are decoded by a device external to the display device, such as by a digital cable box or DVD player, and are transmitted to the display device in an analog or raw digital form. The inventors have recognized that this procedure has several drawbacks. One drawback is that the decoded information that is transmitted to the display device requires a great deal of bandwidth. The required bandwidth increases with the resolution and color detail of the video stream. Thus, for a sufficiently high quality video stream, the bandwidth required will be too great for the connection between the external device and the display device to handle. Another drawback is that a digitally encoded stream that is encrypted for security reasons (e.g., copy protection) must be decrypted before it is sent to the display device if the display device does not incorporate circuitry for decrypting the encoded stream. This decoded stream can be intercepted and/or copied as it is transmitted from the external device to the display device.

The inventors understand that such drawbacks might be alleviated by sending digitally encoded streams directly to the display device. However, sending digitally encoded streams directly to the display device would be expected to make it very difficult for intermediary devices (devices between the original encoder of the stream and the decoder in the display) to add overlays to the signal. Video overlays are commonly used, for example, to superimpose interactive menus on a video signal, to overlay textual or graphical information on a video signal, and to display multiple video signals simultaneously.

Various methods for overlaying video streams are known. For example, chroma keying is a method for removing a specified color or color range from a video stream to reveal the corresponding portions of a background video stream. Alpha blending is another common overlaying method providing for the convex combination of individual picture points (pixels), which provides a similar transparency effect. Pixel or block substitution is used to replace a numerically or geometrically specified range of pixels from one image with a similarly specified range of pixels from another image.

It is desirable to provide a method and device that reduces bandwidth necessary to transmit information to a display device. It is also desirable to provide a method and device that can reduce the possibility of interception and/or copying of decoded information. It is also desirable to provide a method and device that reduces bandwidth necessary to transmit information to a display device, that can reduce the possibility of interception and/or copying of decoded information, and that does not prevent overlaying of video streams.

In accordance with an aspect of the present invention, a method for handling image information in a display device comprises providing to the display device a primary encoded stream, providing to the display device a secondary encoded stream, and decoding the primary encoded stream and the secondary encoded stream in the display device via internal circuitry of the display device to produce a primary decoded stream and a secondary decoded stream.

In accordance with another aspect of the present invention, a display device for overlaying encoded steams comprises a decoder within the display device for decoding a primary encoded stream and a secondary encoded stream to produce a primary unencoded stream and a secondary unencoded stream including secondary information and overlay information. The display device comprises an overlay controller for combining the primary unencoded stream and the secondary unencoded stream to produce a composite stream. The display device comprises a display adapted to display images corresponding to the composite stream, the images comprising a primary image corresponding to the primary unencoded stream and a secondary image corresponding to the secondary information overlaid on the primary image corresponding to the overlay information.

### BRIEF DESCRIPTION OF THE DRAWINGS

The features and advantages of the present invention are well understood by reading the following detailed description in conjunction with the drawings in which like numerals indicate similar elements and in which:

FIG. 1 is a block diagram of an apparatus according to an embodiment of the present invention; and

FIG. 2 is a flow chart showing steps in a method according to an embodiment of the present invention.

### DETAILED DESCRIPTION

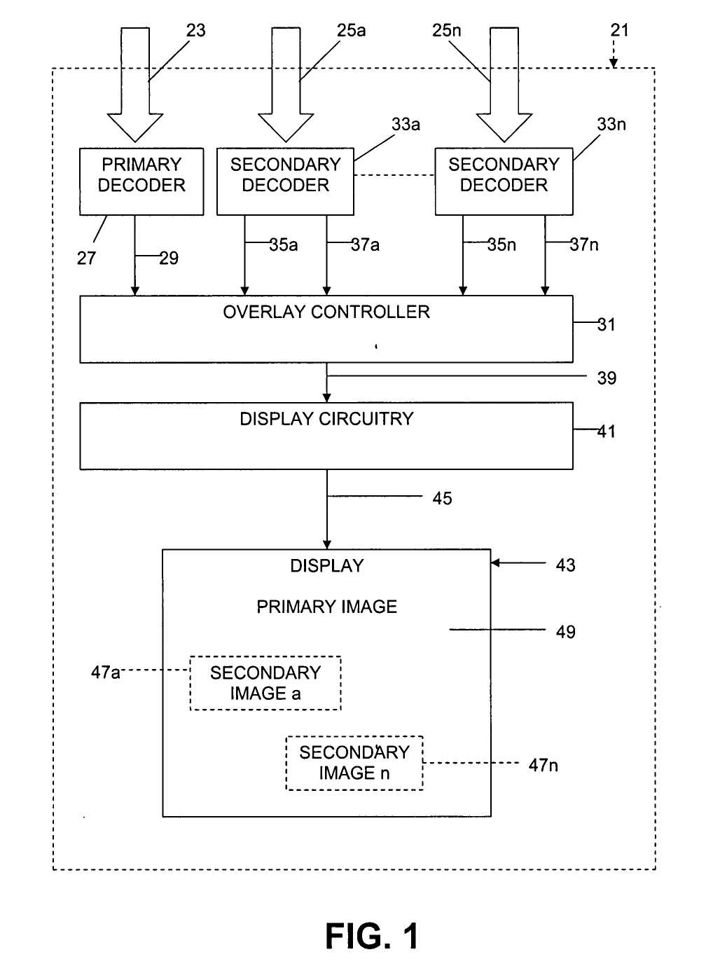

FIG. 1 is a block diagram of a display device 21 according to an embodiment of the present invention. Inputs to the display device 21 include a primary digitally encoded stream 23 and one or more secondary digitally encoded streams 25a-25n. Each of the primary and secondary encoded streams 23 and 25a-25n may be received by the display device 21 via a physical (wired) connection or a wireless signal. While the invention is described in connection with digital streams, it will be appreciated that the invention can be applied to analog streams, as well.

The display device 21 includes a primary decoder 27 that receives the primary encoded stream 23. The primary decoder 27 can include circuitry that can receive the primary encoded stream via an appropriate data transmission protocol. The primary decoder 27 can also include circuitry that can encrypt the encoded stream and/or remove any content protection mechanisms (e.g., CSS, HDCP, DTCP) from the encoded stream. The primary decoder 27 can also include circuitry that can uncompress and otherwise decode the encoded stream in accordance with the stream's specific format (e.g., MPEG-2, MPEG-4, DivX). The primary decoder 27 can also include circuitry that can transmit the decoded primary audio/video stream 29 to the overlay controller 31.

While the primary decoder 27 is illustrated in block form as a single component, it will be appreciated that the circuitry for performing functions that can be performed by the primary decoder can be broken into two or more discrete components which, for purposes of the present application, shall be referred to as a primary decoder.

One or more secondary decoders 33a-33n are provided to receive each of the secondary encoded streams 25a-25n that can include video information as well as overlay information. Each of the secondary decoders 33a-33n can include circuitry that can receive a secondary encoded stream 25a-25n via an appropriate data transmission protocol. Each secondary decoder 33a-33n can include circuitry that can decrypt the encoded stream and/or remove any content protection mechanisms (e.g., CSS, HDCP, DTCP) from the encoded stream. Each secondary decoder 33a-33n can include circuitry that can uncompress and otherwise decode the encoded stream in accordance with the stream's specific format (e.g., MPEG-2, MPEG-4, DivX). Each secondary decoder 33a-33n can include circuitry that can extract and isolate overlay information from the encoded secondary stream. The overlay information may include information relating to how an unencoded secondary stream 35a-35n is to be overlaid relative to the primary unencoded stream 29, and may further include information relating to sampling, resizing, skewing, distorting, and transforming the unencoded secondary stream. Each secondary decoder 33a-33n can include circuitry that can transmit the decoded secondary streams 35a-35n to the overlay controller 29. Each secondary decoder 33a-33n can include circuitry that can transmit overlay information 37a-37n to the overlay controller 31.

A single secondary decoder may be provided to receive one or more secondary encoded streams, or a plurality of secondary decoders may be provided, such as by providing one secondary decoder for each secondary encoded stream. The circuitry for performing functions that can be performed by the secondary decoders can be broken into plural components which, together, shall be referred to here as a secondary decoder. It will further be appreciated that the primary and secondary decoders 27 and 33a-33n may comprise a single decoder device.

The overlay controller 31 can include circuitry to overlay each secondary decoded stream 35a-35n according to its accompanying overlay information 37a-37n onto the primary decoded stream 29 to thereby form a composite stream 39. The overlaying may be done in various ways including. The overlaying may, for example, include chroma keying, i.e., removal of a specified color or color range from a video stream to reveal the corresponding portions of a background video stream. Another way of overlaying may include alpha blending, i.e., the convex combination of individual picture points (pixels) from each stream. Still another way of overlaying may include pixel or block substitution, i.e., replacement of a numerically or geometrically specified range of pixels from one image with a similarly specified range of pixels from another image.

The overlay controller 31 can also include circuitry to transmit the decoded composite stream 39 to the display circuitry 41, which may be conventional display circuitry. The display circuitry 41 will ordinarily convert, if necessary, the decoded composite stream 39 into signals 45 suitable for display 43 of the display device 21. The precise format for these signals will vary among different types of displays.

The display 43 displays images corresponding to the composite video signal 39. The decoded secondary video streams 35a-35n appear as overlaid images 47a-47n overlaid onto a primary image 49 corresponding to the decoded primary video stream 29.

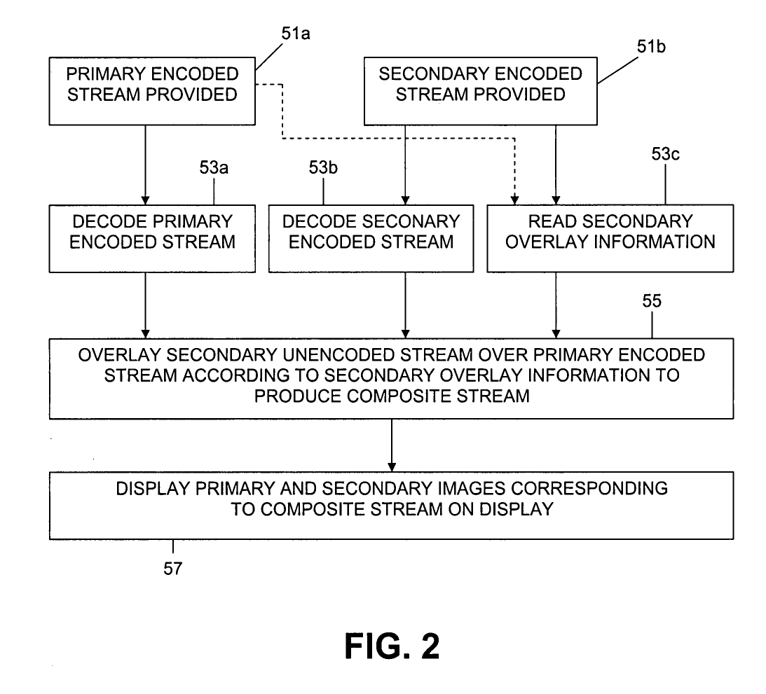

FIG. 2 shows steps in a method according to an embodiment of the present invention. In a first step, 51a the primary encoded stream 23 is received by a primary decoder 27. In a step 51b in parallel with step 51a, one or more secondary encoded streams 25a-25n are received by one or more secondary decoders 33a-33n.

In what shall be considered for purposes of this description as a further step 53a, the primary encoded stream 23 can be decrypted, decompressed, and otherwise decoded in the primary decoder 27. In parallel with the step 53a, what shall be considered for the present purposes to be a step 53b can include decrypting, decompressing, and otherwise decoding the secondary encoded streams 25a-25n in the secondary decoders 33a-33n to produce secondary decoded streams 35a-35n. In parallel with steps 53a and 53b, the overlay information from each of the secondary encoded streams 25a-25n can be extracted and isolated in, e.g., the secondary decoders, in what shall be considered a step 53c to produce overlay information 37a-37n corresponding to the secondary decoded streams 35a-35n.

As seen at step 55, the primary decoded stream 29, the secondary decoded streams 35a-35n, and the overlay information 37a-37n are combined in the overlay controller 31 to produce a composite stream 39 in which each of the secondary decoded streams is overlaid according to its accompanying overlay information onto the primary stream. The composite stream 39 is sent to the display circuitry 41 where it is converted, if necessary, into signals suitable for the display 43. As seen at step 57, a primary image 49 corresponding to the primary decoded stream 29 is displayed on the display 43, and secondary images 47a-47n corresponding to the secondary decoded streams 35a-35n are overlaid onto the primary stream according to the overlay information 37a-37n corresponding to the secondary decoded streams.

While it is presently contemplated that encoded overlay information corresponding to the secondary encoded stream 25a-25n will ordinarily be included as part of the secondary encoded stream, as seen by dotted lines in FIG. 2, some or all of the encoded overlay information may be provided via at least one of the primary encoded stream 23, or via a third source such as another secondary encoded stream (e.g., stream 25n in FIG. 1).

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A method for handling image information in a display device, comprising:
providing to the display device a primary encoded stream;
providing to the display device a secondary encoded stream; and
decoding the primary encoded stream and the secondary encoded stream in the display device via internal circuitry of the display device to produce a primary decoded stream and a secondary decoded stream.

2. The method for handling image information in a display device as set forth in claim 1, wherein the secondary decoded stream comprises secondary information and overlay information for overlaying the secondary information onto the primary decoded stream, the method comprising overlaying the secondary decoded information onto the primary decoded stream to form a composite stream.

3. The method for handling image information in a display device as set forth in claim 2, comprising processing the composite stream and displaying the composite stream on a display of the display device without processing external to the display device.

4. A method for handling image information in a display device as set forth in claim 2, wherein the overlay information comprises at least one of chroma keying, alpha blending, and block substitution information.

5. A method for handling image information in a display device as set forth in claim 2, comprising overlaying the secondary decoded information onto the primary decoded stream using at least at least one overlay controller.

6. A method for handling image information in a display device as set forth in claim 1, comprising providing at least one of the primary encoded stream and the secondary encoded stream as at least one of compressed and encrypted information.

7. A method for handling image information in a display device as set forth in claim 1, comprising providing at least one of the primary encoded stream and the secondary encoded stream as a wireless signal.

8. A method for handling image information in a display device as set forth in claim 1, comprising supplying encoded overlay information corresponding to the secondary encoded stream via at least one of the primary encoded stream and a third source.

9. A method for handling image information in a display device as set forth in claim 1, comprising decoding the primary encoded stream and the secondary encoded stream with at least one decoder circuit.

10. A method for handling image information in a display device as set forth in claim 9, comprising performing at least one of decompression and decryption in the at least one decoder circuit.

11. A method for handling image information in a display device as set forth in claim 1, comprising at least one of sampling, resizing, skewing, distorting, and transforming the secondary stream according to overlay information corresponding to the secondary stream.

12. A display device for overlaying encoded steams, comprising:
a decoder within the display device for decoding a primary encoded stream and a secondary encoded stream to produce a primary unencoded stream and a secondary unencoded stream including secondary information and overlay information;
an overlay controller for combining the primary unencoded stream and the secondary unencoded stream to produce a composite stream;
a display adapted to display images corresponding to the composite stream, the images comprising a primary image corresponding to the primary unencoded stream and a secondary image corresponding to the secondary information overlaid on the primary image corresponding to the overlay information.

13. The display device as set forth in claim 12, wherein the decoder comprises a primary decoder for decoding the primary encoded stream and a secondary decoder for decoding the secondary encoded stream.

14. The display device as set forth in claim 12, wherein the decoder comprises a primary decoder for decoding the primary encoded stream and a plurality of secondary decoders for decoding a plurality of secondary encoded streams.

15. The display device as set forth in claim 12, comprising a wireless receiver for receiving wireless signals corresponding to at least one of the primary encoded stream and the secondary encoded stream.
